(19) United States
(12) Patent Application Publication
(10) Pub. No.: US 2015/0105132 A1
(43) Pub. Date: Apr. 16, 2015

(54) Methods and Kits for Selecting Lottery Numbers

(71) Applicant: Roy D. Gross, Wilton, CT (US)

(72) Inventor: Roy D. Gross, Wilton, CT (US)

(21) Appl. No.: 14/516,059

(22) Filed: Oct. 16, 2014

Related U.S. Application Data
(60) Provisional application No. 61/891,654, filed on Oct. 16, 2013.

(51) Int. Cl. G07F 17/32; A63F 7/04

(52) U.S. Cl. CPC G07F 17/329; G07F 17/323; A63F 7/048
USPC 463/17; 273/144 R

(57) ABSTRACT

Systems and methods to assist in the selection of lottery numbers based on providing a series of questions and correlating the answers of the questions to lottery numbers. The systems and methods involve using a correlation factor or mathematical formula to assist users in selecting lottery numbers.

### FIELD OF THE INVENTION

The present invention relates to lotteries. In particular, the present invention relates to methods and systems that assist a person to select lottery numbers based on providing a series of questions and correlating the answers of the questions to lottery numbers by using a correlation factor and/or table.

### BACKGROUND OF THE INVENTION

Millions of people play lottery games such as POWERBALL® and MEGAMILLIONS® quite frequently. When playing these games, a person may select his or her own numbers or may use the feature whereby a computer randomly generates numbers for the person.

When a person selects his or her lottery numbers, the person typically uses a scorecard, which consists of circles containing numbers, and may select the numbers by filling in the scorecard. In many instances, a person selects the numbers in the scorecard in a random manner. In other instances, a person may know a few numbers that the person wants to select, but is unsure of the remaining numbers and thus, randomly selects the remaining numbers in the scorecard. In these instances, the position of the numbers of the scorecard and the numbers that are already selected often dictate the frequency that the remaining numbers get selected.

By randomly selecting numbers on a scorecard, a person makes blind “guesses” for the lottery numbers. By “guessing” or by randomly selecting numbers, the person does not have any information as to the frequency that certain numbers appear in conjunction with other numbers. Furthermore, by “guessing” or by randomly selecting numbers, the person is unable to select numbers based upon reasons that may be of particular significance to the person or that may be scientific, such as selecting numbers based upon past data of previous lottery events.

As can be seen, there is a need for improved systems and methods to assist a person to select numbers during lottery games whereby the systems and methods assist a person to select numbers. In certain instances, the numbers are of significance to the person and in other instances may be selected due to data from previous lottery events.

### SUMMARY OF THE INVENTION

To improve upon the prior art, the present invention provides methods and systems for assisting a person to select numbers during a lottery game.

In certain embodiments of the present invention, a series of questions are provided, and a person answers the questions, whereby the answers to the questions assist the person to select his/her lottery numbers. In other embodiments, kits and electronic applications are provided, such that a series of questions are stored or presented via such kits and/or electronic applications, whereby the person uses the kits and/or electronic applications to assist the person to select lottery numbers.

In other embodiments, a mathematical and analytical method is provided, so that a person can correlate or link the answers to the questions to lottery numbers via a mathematical formula. In other embodiments, a table and/or a correlation factor is provided, such that the table and correlation factor link the answers to the questions to lottery numbers via an algorithm, thus assisting a person in selecting lottery numbers.

These and other objects of the invention are achieved by providing a method for select lottery numbers comprising: providing at least one question; receiving an answer to the at least one question; and correlating the answer to the at least one question to a lottery number by using a table to correlate the answer to the lottery number.

In certain embodiments, the table includes various algorithms to calculate the lottery number based upon the answer to the at least one question. In certain embodiments, the algorithms includes mathematical formulas that manipulate the answer to the at least one question and correlate the answer to the at least one question to a lottery number.

In certain embodiments, the table includes a correlation factor, the correlation factor being used to correlate the answer to the lottery number. In certain embodiments, the correlation factor relates to the day of the year. In certain embodiments, the correlation factor relates to items of particular significance to the user. In certain embodiments, the correlation factor relates to a number of particular significance to a person. In certain embodiments, the correlation factor relates to astrological events, religious events, or other such events that have mystical or spiritual importance. In certain embodiments, the correlation factor is manually picked by the user.

In certain embodiments, the correlation factor is adjusted depending upon the mathematical frequency of lottery numbers previously selected by the user. In certain embodiments, the correlation factor is adjusted based upon combinations of numbers previously selected as winning lottery numbers.

In certain embodiments, the step of correlating includes counting up the digits in the answer to the at least one question, whereby the answer has a value that corresponds to the number of digits of the answer. In certain embodiments, the step of correlating includes counting up the value of the digits in the answer to the at least one question, whereby the answer has a value that corresponds to the total value of the individual digits of the answer added to one another.

In certain embodiments, if a user does not want to answer a question, the method includes a step of randomly selecting a lottery number instead of receiving an answer to the question. Thus, the user is not required to answer every single question provided by the method when selecting lottery numbers. This allows the user to manually pick lottery numbers if the user so chooses and allows for the set of numbers for the lottery game to consist of some lottery numbers that are the result of the correlation factor and answer to the question (“correlated numbers”) and some of the numbers to be manually selected by the user (“manual numbers”).

In certain embodiments, the step of providing at least one question includes providing a list of questions, the list of questions being set forth in a kit. In certain embodiments, the kit can be a magazine, a book, a booklet and/or other such paper media. In certain embodiments, the kit may be an electronic application, such as a computer program that is stored on a server or electronic device. In certain embodiments, the electronic device may be a tablet, a Smartphone or any other such electronic device that contains electronic circuitry and software that is able to execute a computer program, or software able to execute on a processor. In certain embodiments, the electronic device includes a memory, a database and a storage, such that the electronic device is able to store the questions, the answers to the questions and the correlation factor(s) and algorithms. In certain embodiments, the electronic device includes a memory so that a person's previous entries and selected numbers are stored, so that such information can be used to assist the system to select lottery numbers. In certain embodiments, the electronic device includes links to other devices including lottery devices, so that the lottery numbers selected can be sent to a lottery device to electronically submit lottery entries. In certain embodiments, various types of technologies can be used to send such electronic information, for instance, BLUETOOTH technology or by using a wireless technology.

In certain embodiments, the electronic device includes heuristic learning, such that the system can learn from a person's previously selected lottery numbers and provide those selected numbers as options for selection. Such heuristic learning can take a user's previous “manual numbers” and use those manual numbers when the user does not want to select additional numbers or answer questions.

In certain embodiments, the electronic device is connected to a server, such that the software executing on the electronic device allows the device to be electronically linked to the server and able to send data to the server, such that a person's lottery numbers can be sent to the server. In certain embodiments, the database can store groups of selected lottery numbers and can send the group of numbers to the server, thus, providing multiple selections of lottery numbers. Having multiple selections of lottery numbers can be used when a group of people pool their lottery entries to increase their chances of winning.

Other objects of the invention are achieved by providing a kit for selecting lottery numbers, the kit comprising: a set of questions; a table correlating answers to the set of questions to a series of lottery numbers, such that each answer to a question is correlated to a lottery number.

In certain embodiments, the table includes a chart to count up the digits in each of the answers to the set of questions, whereby each answer has a value that is directed to the value of the digits of the answer.

In certain embodiments, the kit has a set of questions for each day of the calendar or each day which a lottery game is played. In certain embodiments, the kit has a set of questions related to significant events in time, whereby the questions relate to events during the day the lottery game is played.

In certain embodiments, the table in the kit includes various algorithms to calculate the lottery number based upon the answer to the at least one question.

In certain embodiments, the table includes a correlation factor to correlate the answer to the question to the lottery number.

In certain embodiments, the correlation factor is adjusted depending upon the mathematical frequency of lottery numbers previously selected. In certain embodiments, a user uses the table to manually calculate the lottery numbers. In other embodiments, the user enters the answer electronically into an electronic application, which includes the correlation factor to calculate the lottery numbers. In this manner, an electronic device is used in conjunction with a kit.

Other objects of the invention are achieved by providing an electronic application for selecting lottery numbers, the electronic application comprising: a processor; software executing on the processor, the software providing at least one question on a graphical user interface (GUI); software executing on the processor receiving an input from a user of the software in response to the at least one question on the GUI; and software executing on the processor for correlating the input from the person to a lottery number.

In certain embodiments, the input from the user is an answer to the question. In certain embodiments, the input from the user is in the form of a text answer or is in the form of a selection from various options provided to the user, such as selecting from a list of options (i.e., options A-E).

In certain embodiments, the software executing on processor for correlating the input from the user to a lottery number includes a correlation factor. In certain embodiments, the correlation factor is adjusted depending upon the mathematical frequency of lottery numbers previously selected. In certain embodiments, a prompt can be used so that a number is randomly selected if the user does not want to answer the question.

In certain embodiments, the electronic application includes a GUI interface. In certain embodiments, the electronic application includes a database, a memory and a storage, such that the electronic application is stored in the storage and interfaces with the database to store the questions, answers, algorithms and lottery numbers.

In certain embodiments, the lottery numbers are transmitted to a lottery device. In certain embodiments, the lottery device can tabulate a group of lottery numbers from different people, so that a group can pool their lottery selections together. This will allow users to pool their lottery selections together and increase their odds of winning the lottery. In certain embodiments, the electronic application is connected with a database, such that the database can store the lottery numbers selected by members of the group, such that the group members can track the lottery numbers played by the group. In certain embodiments, the database can store information and allow a user to manually input information, so that historical lottery numbers played by the group are stored. In this way, the electronic application allows members of a work group that play lottery numbers together to keep track of the lottery numbers played and who paid, so that a person cannot cheat the remaining group members out of lottery winnings in the event the combination of lottery numbers is a winning combination.

Other objects of the invention involve providing a method and system whereby lottery numbers selected are based on the particular significance of numbers. In certain embodiments, the lottery numbers selected are based on a particular significance of numbers based on the day of the year or based upon astrological evens. In certain embodiments, the lottery numbers are selected based upon events in a religious calendar or with a religious group or religious event.

Other objects of the invention involve providing a method and system whereby lottery numbers selected are based on the preferences of a user and important information of a user, such as the user's birthday, home address and other significant information for the user, or to a user's interests.

In certain embodiments, the lottery numbers selected are based upon the mathematical frequency of the numbers occurring previously, such as the frequency of the numbers in previous lottery events.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 shows a flowchart of a method of an embodiment of the present invention;

FIG. 2 shows an exemplary interface of a kit or electronic application that provides a list of questions for a POWERBALL game;

FIG. 3 shows an exemplary interface of a kit or electronic application that provides a list of answers to the questions of FIG. 2;

FIG. 4 shows a correlation table for the POWERBALL game of FIG. 2 providing rules to select numbers;

FIG. 5 shows how the answers to the questions of FIG. 1 are correlated into lottery numbers via the correlation table of FIG. 4;

FIG. 6 is a flowchart showing steps for using the frequency of previous numbers to select additional lottery numbers based upon mathematical data; and

FIG. 7 shows a chart of an electronic device linked to a server and a lottery device.

### DETAILED DESCRIPTION OF THE INVENTION

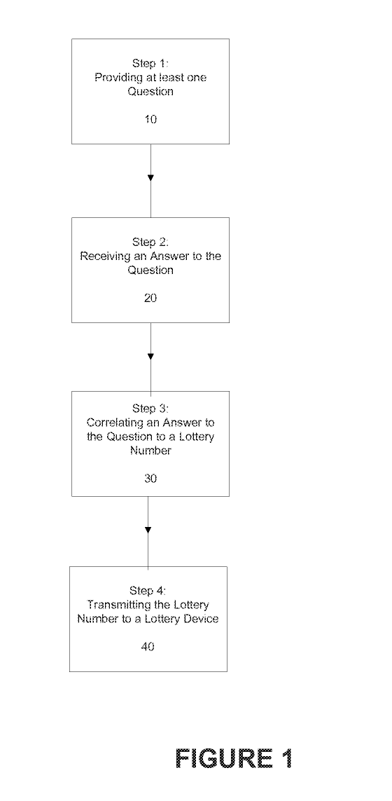

The present invention is directed to methods and systems that assist a person to select lottery numbers based on providing a series of questions and correlating the answers of the questions to lottery numbers by using a table and/or a correlation factor. Turning now in detail to the drawings, FIG. 1 is a flowchart of an embodiment of the present invention.

At 10, a step of providing at least one question is provided. Here, the method involves providing at least one question to a user. In certain embodiments, the at least one question is provided via a kit such as a booklet and in other embodiments, the at least one question is provided via an electronic media. In other embodiments, the at least one question may be provided both by a kit and an electronic media. In certain embodiments, the at least one question may involve asking the user questions that are personal to the user or may involve asking the user questions based upon a user's preferences. In certain embodiments, general questions are asked to a user based upon the specific day or based upon astrological or religious events.

Referring again to FIG. 1, at 20, the method involves the step of receiving an answer to the question. Here, the method receives an answer to the question from a user. In certain embodiments, the user enters the answer into a GUI prompt. In certain embodiments, the user manually records the answer in a booklet.

At 30, the method involves the step of correlating the answer to the question to a lottery number. In certain embodiments, the correlating can be done by a processor or by software running a computer program that correlates the answer to the question to a lottery number. In certain embodiments, the correlation step involves various mathematical algorithms to correlate the answer to a lottery number. In certain embodiments, the correlation step involves applying a correlation factor and/or a table to the answer to transform the answer via the correlation factor to select a lottery number. In certain embodiments, the correlation step involves the user manually applying the answer to the question to a table and use mathematics to arrive at the lottery number.

At 40, the method involves the step of transmitting the lottery number to a lottery device. This is an optional step whereby the lottery number or set of lottery numbers are transmitted to a lottery device, so that a user can have his/her lottery numbers selected. In certain embodiments of the invention, the electronic device communicates with a server to transmit the lottery numbers and submit them to a lottery device. In certain embodiments, the user can have his/her lottery numbers selected and stored, so that person can pool his/her lottery entry with others to increase the chances of winning the lottery (such as win a work group). In certain embodiments, the method is performed on an electronic application or is performed by using a kit.

In certain embodiments, the lottery device is a lottery machine that prints out a hardcopy of the user's lottery numbers. In other embodiments, the lottery device is an electronic application whereby the user's selected lottery numbers are stored in an electronic server and the lottery is conducted electronically.

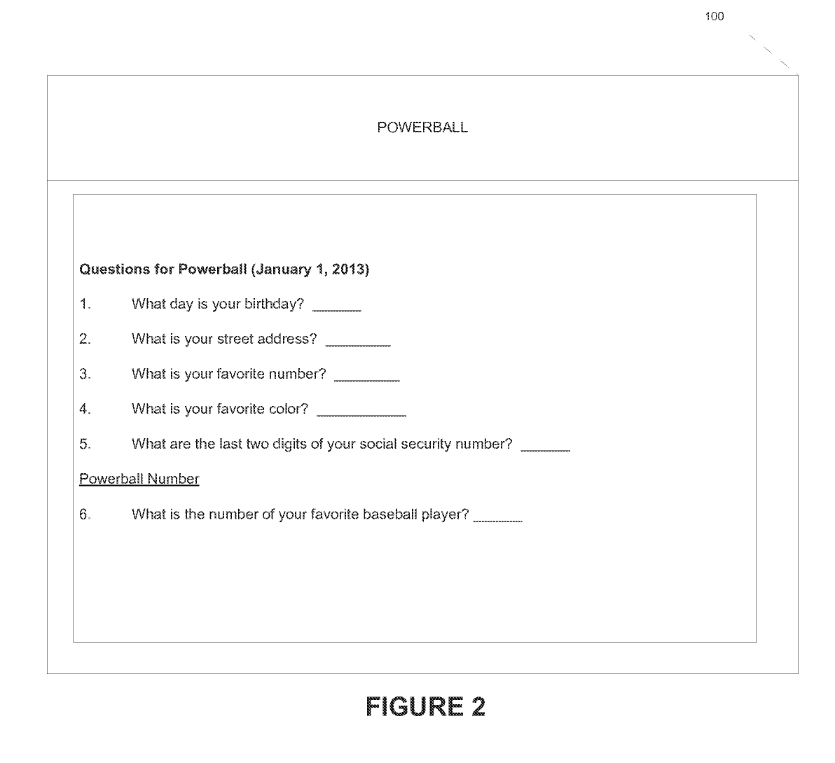

Regarding FIG. 2, an exemplary interface 100 of a kit or electronic application that provides a list of questions for a POWERBALL game is shown. The exemplary interface may be provided in a kit such as a booklet or paper media or may be provided as software, whereby the list of questions is displayed on an electronic device using a graphical user interface (GUI).

As used in this specification, electronic device and internet-connected device are used interchangeably and mean the same thing. Non-limiting examples of these devices are mobile phones, hand-held devices, computers and other devices that can receive and transmit information via the internet, either wirelessly or through wires. Other electronic devices include tablets, such as an IPAD. Other electronic devices include SmartPhones such as the IPHONE or other such phones that contain a computer processor.

In certain embodiments, the list of questions may include various questions each day, such that different questions are asked to a user on different days. For example, as shown in FIG. 2, various questions are provided such as asking the person his or her birthday, street address, favorite color, last two digits of the social security number and number of his/her favorite baseball player.

Other questions may be asked depending upon the day of the year. Other questions may be provided, which are directed to various astrological or significant events of the year and/or questions regarding religious symbolism or mysticism.

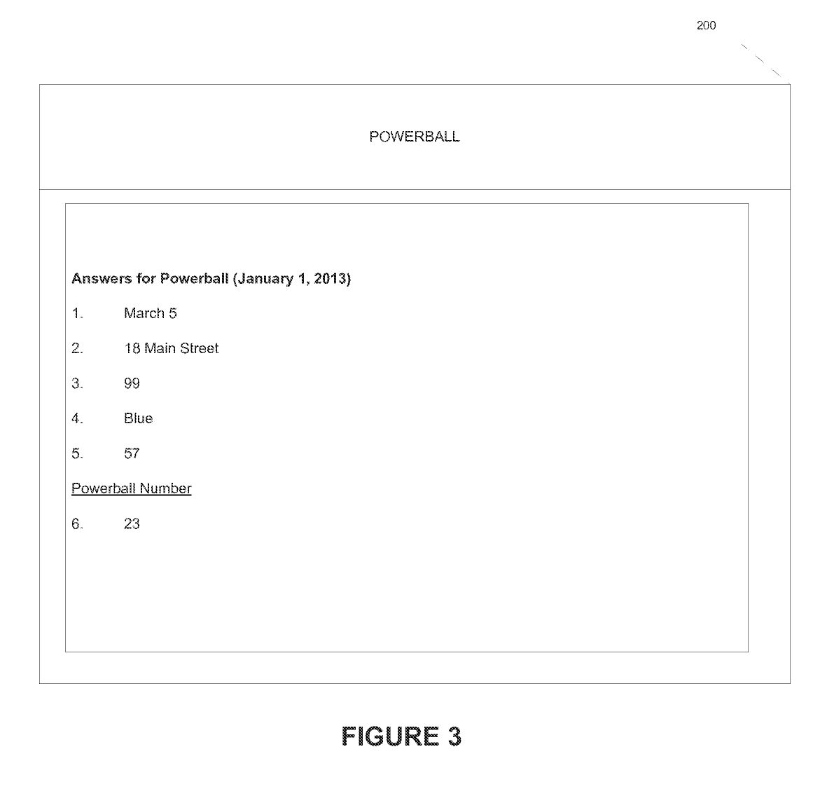

FIG. 3 shows a person's answers to the questions as an example. The person may enter the answers to the questions in the kit 200 or into the electronic application 200 stored on an electronic device. An electronic application, or app, is a piece of software that can run on the Internet, on a computer, on a phone or on another electronic device.

The consumer may acquire the app in any way. As non-limiting examples, a consumer may acquire the app by downloading the app to a mobile phone, Smartphone or to any other internet-connected device, or may acquire the app through CDs, or any other way to transfer software, such as via a USB stick.

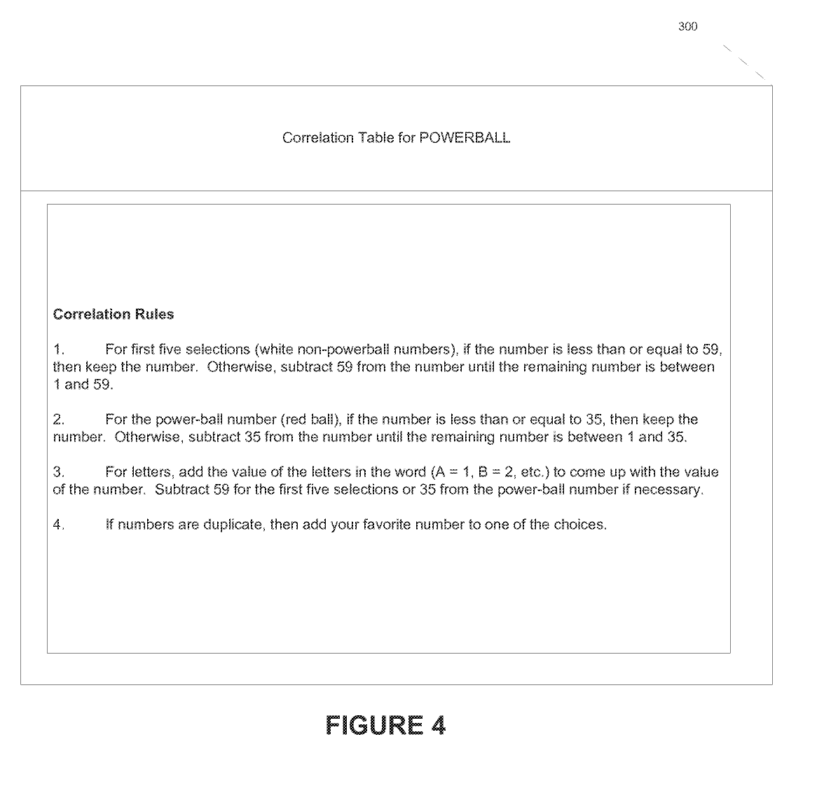

FIG. 4 shows a correlation table 300 having correlation rules to correlate the answers to the questions to the lottery numbers. As the POWERBALL lottery game includes selection from numbers 1-59 for the first five numbers (white balls) and from 1-35 for the powerball-number (red ball), the correlation table provides rules to correlate or translate a person's answers to lottery numbers that fit the POWERBALL game.

The correlation table is simply an example and other correlation tables are provided which work for other lottery games such as MEGA MILLIONS, and other such lottery games. The invention is directed to all lottery games and separate correlation tables can be used for different lottery games not described in the specification.

In certain embodiments, the correlation table includes using a correlation factor or mathematical formula to translate the person's answers into lottery numbers. Such a correlation factor may take the user's answers and multiple them by 2 or divide the answers by various factors to normalize the numbers to the particular lottery game. Other correlation factors include using significant data to a person. Other correlation factors involve asking the user to enter a correlation factor and converting the answers to the lottery questions by using the correlation factor via an algorithm.

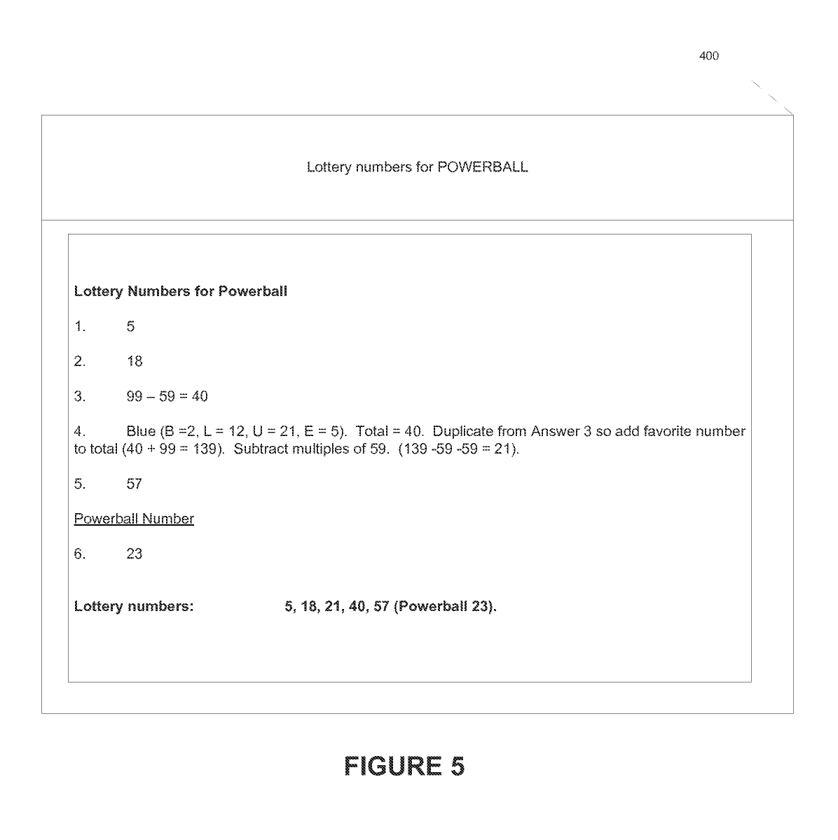

As shown in FIG. 5, the answers to the questions of FIG. 1 are correlated into lottery numbers on interface 400 via the correlation table of FIG. 4. Here, the answers to the first two questions are directly correlated into lottery numbers by not altering the number. However, for question 3, the correlation table is used to subtract 59 from the user's favorite number (99), so that the number can be used in a POWERBALL game format.

Furthermore, in FIG. 5, the value for each of the letters of the color BLUE are added together to arrive at the number 40, which is a duplicate of the answer to question #3. The correlation table follows another rule in the correlation table to add the favorite number to the total of the value of the letters in BLUE, which is then normalized by subtracting 59 twice to arrive at 21, which is used as a lottery number.

Other correlation factors can be used depending upon the correlation table, which is dynamic, when it is part of the electronic application. In the kit, a different correlation table can be used each day to assist the user to select lottery numbers. Other correlation factors can be used based upon different lottery games. In certain embodiments, a user can manually select a correlation factor or can answer a question to arrive at a correlation factor.

In certain embodiments, the correlation factor is linked to astrological events or to events based upon the day. For example, on July 4, the correlation factor could be to add the value of the digits for the word AMERICA to each of the lottery numbers.

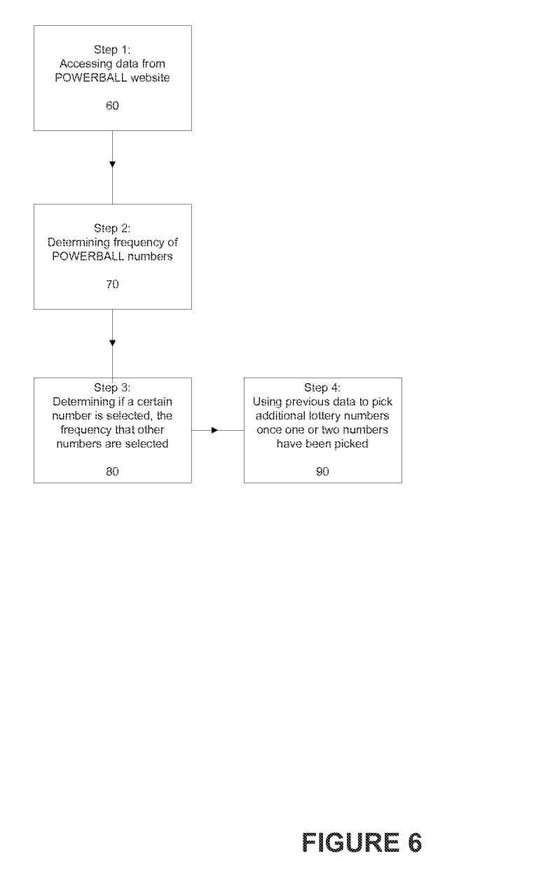

In FIG. 6, a mathematical formula is used to link the lottery numbers selected to a formula based on previous results. In FIG. 6, step 1 at 60 involves accessing the data stored in http://www.powerball.com/powerball/pb_frequency.asp and http://www.powerball.com/powerball/pb_nrb_history.asp, for example, to use data from previous lottery events to arrive at lottery numbers for future lottery events.

Step 2 at 70 involves mining through the data to determine the frequency of the numbers previously provided and to determine which numbers occur together with the greatest frequency.

For instance, it can be determined that the number 29 has a frequency of being the powerball number approximately 10% of the time from 1/18/12 till 9/11/13. A user can then have the number 29 be selected if he or she desires the most frequent Powerball number in the past 18 months.

Step 3 at 80 of the method involves determining the frequency of numbers being selected with relation to another number being selected based on past experiences. For example, if the number 2 is selected as a one of the five non-powerball numbers by a person, the method determines the frequency that the number 29 will occur as the powerball number. This will allow persons who select one or two numbers out of the five and to mathematically select the other numbers with the greatest frequency of occurring based upon prior results.

Step 4 at 90 of the method involves using previous data to pick additional lottery numbers once one or two numbers have been picked. This involves mining through the data and mathematically determining which numbers have most frequently occurred with other numbers.

While this mathematical formula may not guarantee success as it does not guarantee selecting the correct lottery numbers, the method uses past data to provide information, whereby lottery numbers are selected based upon a mathematical formula determined on previous results.

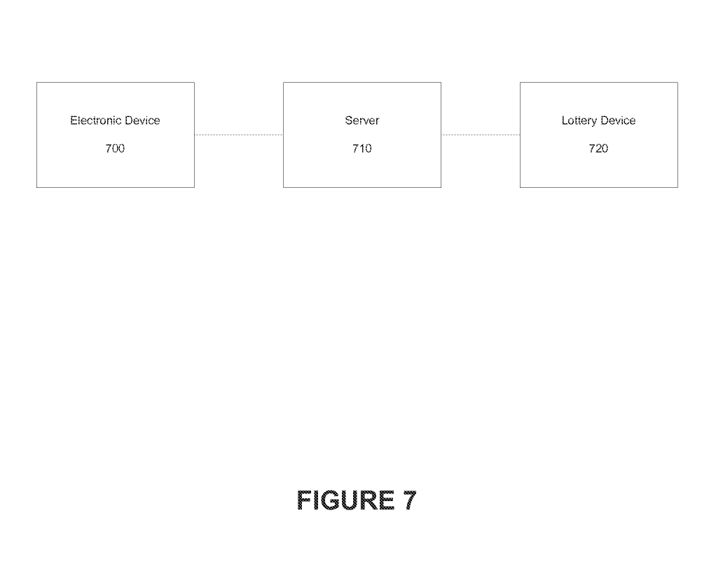

FIG. 7 shows the electronic device 700 connected to a server 710, which is connected to a lottery device 720. In this way, the user may answer the questions to select lottery numbers, which are transmitted to a lottery device for the user.

In other examples of the invention, an electronic application is used to store numbers selected by a group, such that the electronic application is linked to a database and allows various lottery plays to be stored and tracked. In this way, a work group or a group of people pooling their resources to select lottery numbers have an ergonomic and efficient system to use to keep track of their lottery numbers and to ensure that members of the group do not cheat other members of the group of possible lottery winnings.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A method for assistance in the selection of lottery numbers, the method comprising:
providing at least one question;
receiving an answer to the at least one question; and
correlating the answer to the at least one question to a lottery number by using a table to correlate the answer to the lottery number.

2. The method of claim 1, wherein the step of correlating includes counting up the digits in the answer to the at least one question, whereby the answer has a value that corresponds to the number of digits of the answer.

3. The method of claim 1, wherein the step of providing at least one question includes providing a list of questions, the list of questions being set forth in a booklet.

4. The method of claim 3, whereby the booklet has a set of questions for each day of the calendar or each day which a lottery game is played.

5. The method of claim 1, wherein the table includes various algorithms to calculate the lottery number based upon the answer to the at least one question.

6. The method of claim 1, wherein the step of providing at least one question includes providing a list of questions, the list of questions being set forth in an electronic application.

7. The method of claim 1, wherein the table includes a correlation factor, the correlation factor used to correlate the answer to the lottery number.

8. The method of claim 8, wherein the correlation factor is adjusted depending upon the mathematical frequency of lottery numbers previously selected.

9. A kit for assistance in the selection of lottery numbers, the booklet comprising:
a set of questions;
a table correlating answers to the set of questions to a series of lottery numbers, such that each answer to a question is correlated to a lottery number.

10. The kit of claim 10, wherein the table includes a chart to count up the digits in each of the answers to the set of questions, whereby each answer has a value that is directed to the value of the digits of the answer.

11. The kit of claim 10, wherein the kit has a set of questions for each day of the calendar or each day which a lottery game is played.

12. The kit of claim 10, wherein the table includes various algorithms to calculate a lottery number based upon an answer to a question.

13. The kit of claim 10, wherein the table includes a correlation factor to correlate an answer to the question to a lottery number.

14. The kit of claim 14, wherein the correlation factor is adjusted depending upon the mathematical frequency of lottery numbers previously selected.

15. An electronic application for assistance in the selection of lottery numbers, the electronic application comprising:
a processor;
software executing on the processor, the software providing at least one question on a graphical user interface (GUI);
software executing on the processor receiving an input from a user in response to the at least one question on the GUI;
software executing on processor for correlating the input from the person to a lottery number.

16. The electronic application of claim 16, wherein the input from the user is an answer to the question.

17. The electronic application of claim 16, wherein the software executing on the processor for correlating the input from the user to a lottery number includes a correlation factor.

18. The electronic application of claim 16, wherein the correlation factor is adjusted depending upon the mathematical frequency of lottery numbers previously selected.
